(19) United States
(12) Patent Application Publication
(10) Pub. No.: US 2007/0044921 A1
(43) Pub. Date: Mar. 1, 2007

(54) Apparatus for applying heat/pressure-activated labels to pre-formed automotive interior panels

(75) Inventor: Richard J. Jarecki, Sand Lake, MI (US)

Correspondence Address: BULLWINKEL PARTNERS, LTD., 19 S. LASALLE STREET, SUITE 1300, CHICAGO, IL, 60603, US

(73) Assignee: Laser Die and Engineering

(21) Appl. No.: 11/216,717

(22) Filed: Aug. 31, 2005

(51) Int. Cl. B65C 9/18

(52) U.S. Cl. 156/541

(57) ABSTRACT

An apparatus for automatically applying heat-activated adhesive warning labels to the downward-facing (finished) side of an automotive headliner. The headliner is supported on a rack in a reverse-side up position, thereby permitting additional assembly operations to be performed on the upward-facing (reverse) side while the apparatus automatically applies warning labels to the downward-facing (finished) side. After the assembly operations have been completed and the labels applied, the completed headliner is removed from the rack and is ready for assembly into a vehicle, rather than having to be inverted in a second operation for application of the warning labels as had been required in previous practice.

### FIELD OF THE INVENTION

The use of automatically inflatable passenger restraint devices, commonly called “airbags”, has become increasingly common in passenger automobiles. Initially used to protect driver and passenger from head-on collisions, airbags are also commonly provided for protection from side-impact collisions, as shown in Muhlbacher et al. U.S. Pat. No. 6,443,485 (Sep. 3, 2002).

More recently, roll-down curtain-like devices have been developed which are stowed behind or within the automobile's interior roof trim, known as a headliner. One such curtain-like airbag is shown in Matsumoto U.S. Pat. No. 6,497,492 (Dec. 24, 2002). Another roof rail or headliner mounted airbag is shown by Daniel, U.S. Pat. No. 5,540,459 (Jul. 30, 1996)

The safety provided by automotive airbags does not come without its own risks, because by its nature an airbag contains a pyrotechnic device which delivers a virtually instantaneous burst of high-pressure inflation gas sufficient to inflate the “pillow” portion and interrupt the inertial movement of the vehicle's occupants before they can impact some unyielding structure within the vehicle's passenger compartment. A typical gas generator unit for a curtain-like side-protection airbag is disclosed by Matsumoto U.S. Pat. No. 6,497,429 (Dec. 24, 2002). A modular headliner assembly incorporating a plurality of airbag modules and gas-generating canisters is shown by Picken, et al. U.S. Pat. No. 6,523,887 (Feb. 25, 2003).

In other words, all airbags, including even the smaller ones employed for side-impact protection, are in effect explosive devices. The interests of safety therefore require the placement of a suitable warning label within the vehicle in plain sight of the occupants, to fairly placement of a suitable warning label within the vehicle in plain sight of the occupants, to fairly inform them of the fact that one or more airbag is armed and ready for deployment into their personal space in the event of an impact accident. Desirably, each airbag must be provided with its own warning label. The front-impact airbags have warning labels directly in front of the passengers, and the side-impact airbags similarly have a label at each airbag location at the sides of the passenger compartment. In the case of headliner-mounted airbags, whether of the roll-down curtain type or otherwise, a label is desirably placed on the headliner itself, at or near the position of each airbag.

### BACKGROUND OF THE INVENTION

Vehicle headliners are commonly made of plastic or composite plastic and fabric material, and are generally of molded multi-layered construction, as disclosed by Corpe et al. U.S. Pat. No. 5,795,015 (Aug. 18, 1998). It is also common to include in the vehicle headliner multiple vehicle accessories such as overhead lights, loudspeakers, and the “third brake light” now required by the automotive safety regulations of the U.S.A. and other countries. Assembly of these additional components is commonly done by placing each molded headliner in a reverse-side up position on a waist-level rack or other suitable support to enable the assembly workers to conveniently install airbags, lighting fixtures, loudspeakers, wiring, and other such devices and accessories which will be largely invisible to the vehicle occupants after the finished headliner has been installed.

While the headliner is most conveniently accessible for such assembly operations in such a reverse-side up position, it has been difficult or impossible for workers to apply airbag warning labels to the finished (downward-facing) of the headliner without removing the otherwise finished headliner from the rack or support, inverting it and placing it reverse-side down on another rack or support so that the warning labels can be manually applied to the airbag-covering surfaces as required. Such labels are commonly heat-activated or heat-sensitive, and are produced in pre-cut form on continuous rolls or drums of adhesive-release backing paper, with the printed label information on one surface, and the heat-sensitive adhesive on the other. Such labels are customarily applied by hand using a heated press or iron which is a time-consuming and labor-intensive process, and susceptible to operator error in that a label may be misapplied by being skewed, or in the wrong location, which is difficult or impossible to correct.

There are other disadvantages to manual application of heat-sensitive warning labels. A separate tool is needed. The heated ram poses its own danger to a manual operator, often requiring safety guards or light curtain triggered sweeps to prevent the operator from inadvertently contacting the hot surface or the ram.

Automated label application processes are known for use in other applications, such as Shiraishi U.S. Pat. No. 6,652,687 (Nov. 25, 2003) which discloses a rotating vacuum drum which draws a strip of heat-sensitive labels from a continuous roll and sequentially applies each label to individual parts or products as they are drawn by on a conveyor. In this application the label (printed) side is held by suction face-down on the roll with the heat-sensitive adhesive side facing up to meet the article to which it is to be applied. Unless a carrier strip is used, a cutter is required to separate each label from the next.

It is therefore a principal object of the invention to provide a means for applying airbag labels to vehicle headliners with the headliner in a reverse-side up position and in an automated manner, thereby allowing other assembly functions to be performed at the same time, and eliminating the need to turn the headliner over for completion of the label application function.

Another object of the invention is to automate the application of heat-sensitive warning labels to vehicle headliners in a reverse-side up position so that potentially dangerous manual operations are not required, and to locate the heated adhesive-activating apparatus beneath the headliner out of the way of the assembly personnel to reduce or eliminate the danger of burns.

A further object is to make each label applicator so compact that multiple label applicators can be simultaneously utilized in a single one headliner assembly rack or support, eliminating multiple operations on the same headliner, and permitting the applicators to be fitted into tighter areas within the interior-side face of the headliner, such as sharp interior corners.

### SUMMARY OF THE INVENTION

The invention consists of an apparatus for automatically applying heat-activated adhesive airbag warning labels to the downward-facing (finished) side of an automotive headliner. The headliner is supported on a rack in a reverse-side up position, thereby permitting additional assembly operations to be performed on the upward-facing (reverse) side while the apparatus automatically applies warning labels to the downward-facing (finished) side. After the assembly operations have been completed and the labels applied, the completed headliner is removed from the rack and is ready for assembly into a vehicle, rather than having to be inverted in a second operation for application of the warning labels as had been required in previous practice.

### A BRIEF DESCRIPTION OF THE DRAWINGS

FIG. 1 is a perspective view of the apparatus of the present invention, showing a pre-molded automotive headliner supported reverse-side up (finished side down) in position for further assembly.

FIG. 2 is a perspective view similar to FIG. 1 showing the apparatus with the headliner removed, illustrating the multiple automated application devices for application of heat-sensitive warning labels to the downward-facing (finished) side of the headliner;

FIG. 3 is a detailed perspective view of a roll of cloth heat-sensitive labels on their supporting release-coating backing tape, with their heated sides up and printed (cloth) sides down.

FIG. 4 is a perspective view of one of the label application units showing a roll of release-coated backing tape carrying spaced heat-sensitive pre-printed cloth labels ready for application, and with the heated pressure ram in its lower (retracted) position; and

FIG. 5 is a perspective view similar to FIG. 2 with the heated pressure ram in its upper (extended) position.

### DETAILED DESCRIPTION OF THE INVENTION

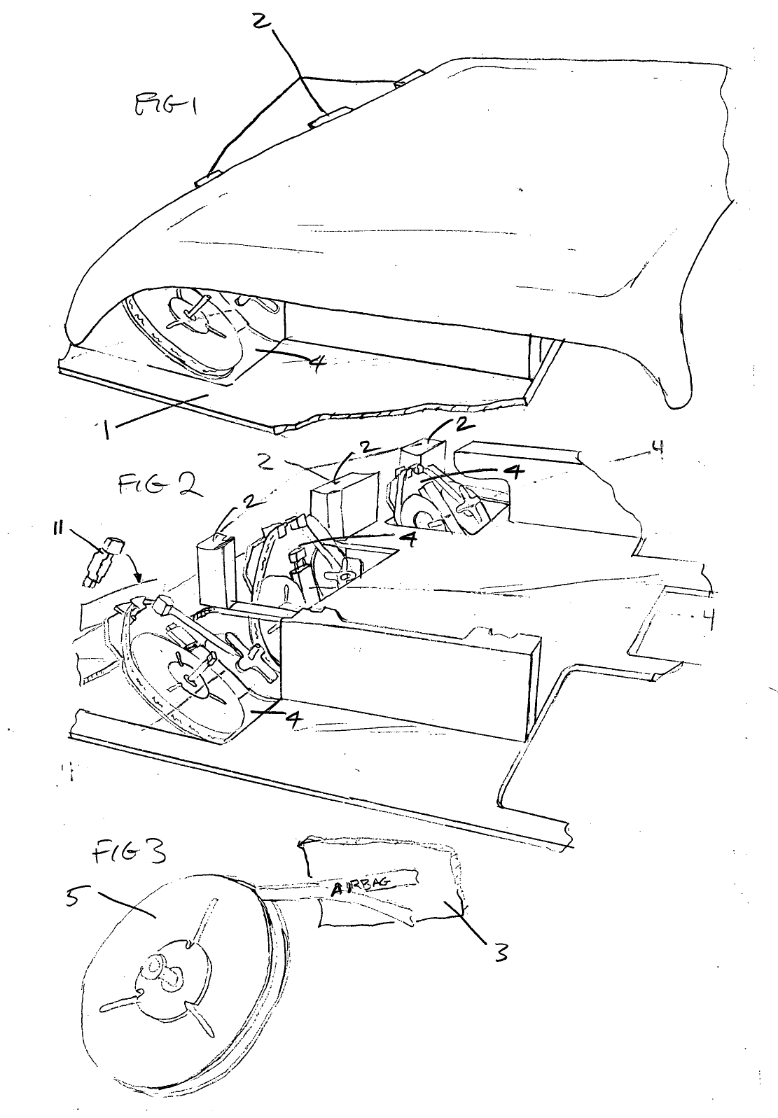

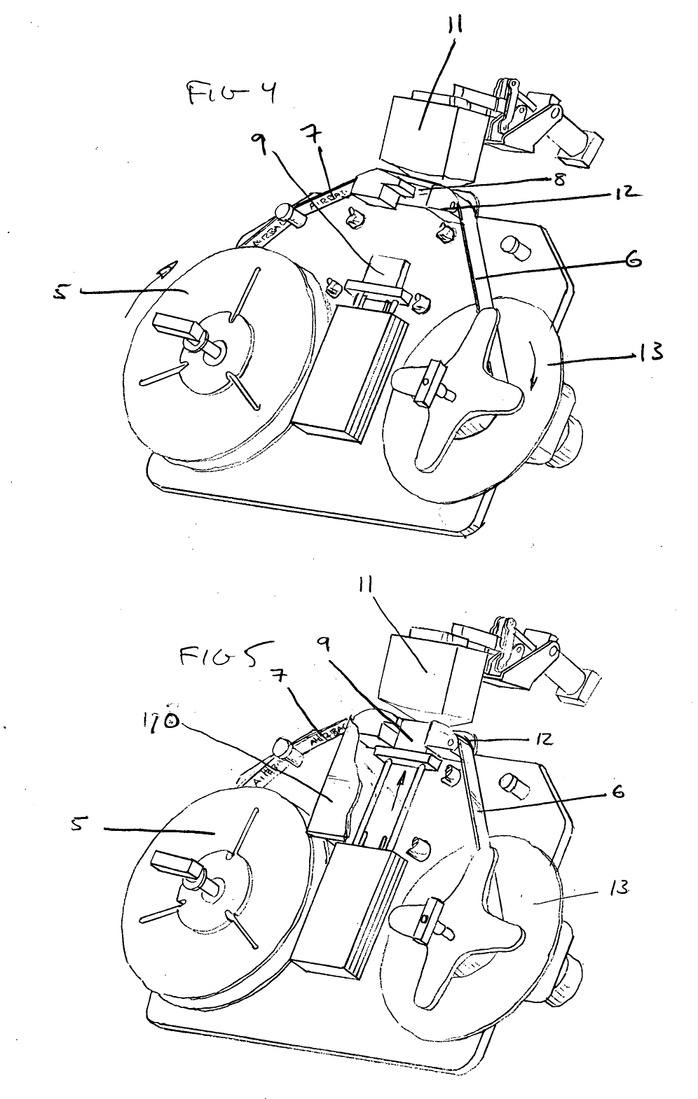

In the drawings, FIG. 1 shows a pre-molded headliner secured in place on the rack 1 incorporating the present invention. The rack 1 locates and supports the headliner upon a plurality of fitted support points 2, holding the headliner securely in place at approximately waist height for the comfort and convenience of assembly workers, who can easily move about the periphery of the headliner to perform various assembly tasks such as installation of interior lights, loudspeakers, and wiring looms. In particular, the rack 1 holds the headliner in place for installation of one or more individual airbag units 3 spaced around the periphery of the headliner in positions corresponding to the seat locations of passengers seated within the completed vehicle.

Referring to FIG. 2, the rack 1 is shown with the headliner removed, showing the rack's multiple support surfaces which are positioned and shaped to engage and support the periphery of the pre-formed headliner. At each point where an airbag is to be installed, a label application unit 4 is located beneath the headliner where it addresses the downward-facing (finished) side of the headliner where the label is to be applied.

Each label application unit 4 incorporates a supply reel 5 containing a roll of pre-printed and pre-cut cloth warning labels carried in spaced array by a continuous backing tape 6. The pre-printed labels 7 are delivered continuously to each application unit 4 with the pre-printed (cloth) side of the label facing down against the backing tape and the attachment side, which is coated with heat-activated adhesive, facing up away from the tape. The tape and its labels 7 are carried in stepwise fashion from the supply reel 5 to an attachment station 8 where an electrically heated ram 9 is sequentially and automatically extended to engage each label, activate its outward-facing adhesive surface by thermal conduction through the backing tape, and to press the heat-activated adhesive side of the label onto the headliner at the desired station.

An anvil or back-up block 11 then moves to engage the reverse side of the headliner at the application point to prevent it from moving as the headliner is contacted by the heated ram 9 in pressing the label into place. Upon completion of its stroke, the ram 9 retracts, leaving the label adhered to the headliner in its proper place, so that the label is allowed to cool. The anvil block 11 then retracts to its starting position. Because the heated ram 9 retracts into its protective tunnel 10, it is removed from vicinity of the edge of the device where assembly personnel might otherwise inadvertently come in contact with it.

After each extension stroke, the ram 9 retracts into a protective tunnel 10 to prevent inadvertent contact by assembly personnel working on the upward-facing (reverse) side of the headliner. After passing through the attachment station 8, the now-empty backing tape 6 feeds through tape guides 12 under tension provided by a powered take-up reel 13.

The several label application units may be energized either sequentially or in unison, either at the start of the headliner assembly process or after some or all of the other components (lights, wiring, air bags) have been installed by assembly workers on the top-facing (reverse side) of the headliner.

### REFERENCE NUMERALS

1. Rack
2. Support point
3. Airbag unit
4. Label application unit
5. Supply reel
6. Adhesive release backing tape
7. Pre-printed label
8. Attachment station
9. Electrically heated adhesive-activating ram
10. Protective tunnel
11. Anvil (back-up block)
12. Tape guides
13. Take-up reel

I claim:

1. An apparatus for applying heat-activated adhesive warning labels to an automotive headliner having a finished side requiring the application of said warning labels and a reverse side requiring installation of additional components by assembly personnel, comprising:
(a) rack means for supporting said headliner in a horizontal position, finished side down, at a convenient height for the installation of said additional components, and
(b) at least one label application means comprising
i) a supply reel holding a spool of supporting tape carrying a plurality of spaced pre-cut heat-activated labels,
ii) heated ram means operable between a retracted position removed from inadvertent contact by said assembly personnel and an extended position for pressing one said warning label into position on the finished side of said headliner,
iii) retractable anvil means operable to back up said headliner against movement under pressure from said ram means, and
iv) powered take-up reel means for drawing forth and storing said supporting tape after application of the labels carried thereon.

2. Apparatus as claimed in claim 1 in which said label application means further included a protective tunnel covering heated ram means from contact by said assembly personnel while in said retracted position.
